(19) United States
(12) Patent Application Publication
(10) Pub. No.: US 2021/0121353 A1
(43) Pub. Date: Apr. 29, 2021

(54) PHYSICAL THERAPY DEVICE AND METHOD FOR STRETCHING MUSCLES IN THE FOOT

(71) Applicant: William J. Flickinger, Wadsworth, OH (US)

(72) Inventor: William J. Flickinger, Wadsworth, OH (US)

(21) Appl. No.: 16/667,622

(22) Filed: Oct. 29, 2019

(51) Int. Cl. A61H 1/02

(52) U.S. Cl. CPC A61H 1/0266; A61H 2201/1269; A61H 2201/169; A61H 2201/1642; A61H 2201/1635

(57) ABSTRACT

A device and method for engaging the foot distal to the metatarsi that enables a full stretch of the plantar fascia, muscles of the feet and lower leg. The invention has an elongated shaft that has a brace element affixed to the end of the shaft pointed away from a human user and a handle element affixed to the opposite end of the shaft. When the handle element is pulled toward the human user, the brace element engages the foot such that the intended stretch on the plantar and posterior portions of the foot and leg is initiated.

### BACKGROUND

### Technical Field

The present disclosure relates to physical therapy. More particularly, and not by way of limitation, the present disclosure is directed to an apparatus and method for stretching the plantar fascia and tendons and muscles located in the foot and on the back of the leg.

### Description of Related Art

The plantar fascia is located on the bottom of the foot or the plantar side. Plantar fasciitis is inflammation of the fascia and causes pain. It can be aggravated when walking, running or standing and the pain can be debilitating. Stretching of the fascia and tendons and muscles on the dorsal side or back the leg can reduce this pain. However, active stretching, such as when the person is standing and stretching using a slant board or other device can cause the targeted muscles to contract, putting undue tension on the tendons, which can result in micro tears, which cause further pain. Elastic or inelastic bands and even towels are often recommended but are cumbersome to use. The angle of stretch is difficult to control. They are often looped around the arch of the foot and this does not stretch the plantar fascia. Stretching by contracting the antagonistic muscles of the anterior leg can cause cramping and tightening of those muscles and in extreme cases, shin splints. It would be advantageous to have an apparatus and method for engaging the foot distal to the metatarsi that enables a full stretch of the plantar fascia, muscles of the feet and lower leg that overcomes the disadvantages of the prior art. The present disclosure provides such a system and method.

### BRIEF SUMMARY

The present disclosure is directed to an elongated shaft that is held approximately parallel to the long axis of the leg, at least a brace element that is attached to the elongated shaft that is oriented such that it is held perpendicular to the long axis of the leg. The brace element is oriented essentially perpendicular to the long axis of the leg such that when engaged with the foot the foot is in the neutral position. The brace element is configured to be long enough to engage the width of the foot. The elongated shaft may include a grip or handle attached to the end opposite from the brace element. The elongated shaft may be adjustable to fit the user, with the grip easily gripped between the knee and hip.

The brace element and the handle element may include a hinge that enables these elements to fold essentially parallel to the elongated shaft for storage and transport. Grips on the elongated shaft or the brace element and handle element allow for the placement of the foot and hands to reduce the chance of slippage. The grips may conform to the toes and the fingers of the hand to improve grip. The material of the elongated shaft, brace element, and/or handle element may be metal, such as steel or aluminum, carbon fiber, wood, or plastic. The handle may be rubber, plastic, leather, or other material that offers cushioning and a high coefficient of friction to reduce slipping. The brace element may include a conical element that can be used to manipulate pressure points

The invention includes a method of stretching the plantar fascia and tendons and muscles on the plantar side of the foot and the posterior lower leg whereby the user is seated with the leg extended in front of them such that the whole leg is supported or slightly declined such that the upper leg and upper portion of the lower leg is supported by the seat. This enables the muscles of the legs to be relaxed as they are not supporting the body. The user then engages the brace element with the foot distal to the metatarsi, under the toes. The user then assures the foot is in the neutral position, neither supinated nor pronated. The stretch is initiated by pulling the elongated shaft with the handle element in a superior direction along the axis of the leg until the desired degree of stretching is achieved.

The user holds this position for several seconds and releases the stretch by moving the elongated shaft inferiorly to allow the foot to regain the neutral position. The user repeats this maneuver several times and repeats with the other foot, particularly if the condition is bilateral. For instance, a set of 10 stretches per leg, each stretch held for 10 seconds, each set performed twice a day may be an appropriate therapy. This improves range of motion of the foot and ankle, reduces Ankle Equinus, relieve knee pain, back pain and hip pain associated with misalignment of the foot and ankle. It reduces over pronation and the tension on the plantar fascia.

### BRIEF DESCRIPTION OF THE DRAWINGS

The novel features believed characteristic of the disclosure are set forth in the appended claims. The disclosure itself, however, as well as a preferred mode of use, further objectives and advantages thereof, will be best understood by reference to the following detailed description of illustrative embodiments when read in conjunction with the accompanying drawings, wherein:

FIG. 1 is a depiction of one embodiment of the present invention, specifically illustrating the location of the handle element and the brace element.

FIG. 2 is an alternate embodiment of the present invention, specifically illustrating a different type of handle that can be affixed to the invention.

FIG. 3 is a telescoped view of the adjustment mechanism as found in an alternate embodiment of the present invention.

FIG. 4 is a telescoped view of the hinge mechanism as found in an alternate embodiment of the present invention.

FIG. 5 is an alternate embodiment of the present invention, specifically illustrating a combination of perpendicular arms for both the brace element and the handle element.

FIG. 6 is an alternate embodiment of the present invention, specifically illustrating the adjustment mechanism.

FIG. 7 is an alternate embodiment of the present invention, specifically illustrating the location of the conical element on the brace element of the present invention.

FIG. 8 is a perspective view of another embodiment of the present invention depicting the placement of the device in relation to the planter surface of the foot of the user.

FIG. 9 a perspective view of another embodiment of the present invention depicting the placement of the device in relation to the foot of the user from the medial side of the right foot of the user, the direction of pull and the resultant direction of stretch of the foot around the axis of the ankle.

### DETAILED DESCRIPTION

The present invention is directed to a physical therapy device and method of treatment of the plantar surface of the foot and the posterior muscles and tendons of the leg. The physical therapy device includes a handle and an elongated shaft that extends from approximately mid-thigh to beyond the bottom of the foot, where the shaft bends such that a brace element is formed that is essentially positioned perpendicular to the shaft. The brace element is configured with a non-slip surface to grip the toes.

In one embodiment, a handle is at the top of the elongated shaft by grip along its axis. In yet another embodiment, the shaft may include a handle that is perpendicular to the elongated shaft. In another embodiment, the handle may be hinged to fold such that it is parallel to the elongated shaft for storage. In yet another embodiment, the handle is fashioned such that the center of the handle is more or less centered to the first shaft. In any of the embodiments, the brace element engaging the foot may also be hinged such that it can be folded so that it is parallel to the elongated shaft for storage.

In any of the embodiments, the elongated shaft may be adjustable along its length to accommodate a variety of leg lengths. Furthermore, the elongated shaft can be constructed from a wide variety of materials including, but limited to, any type of metal, wood, polymer, or carbon fiber. This disclosure also describes a method of unweighted stretching of the tendons, fascia and muscles of the plantar surface of the foot and the posterior of the leg. The unweighted nature of the stretch reduces the chances of incidental macro and micro tears of the tendons of the ankle and around the heel from muscle activation in response to postural demands. It reduces the foreshortening of the anterior leg muscles when these are used to dorsiflex the foot to stretch the targeted structures. These and other features of the disclosure are described in the paragraphs below.

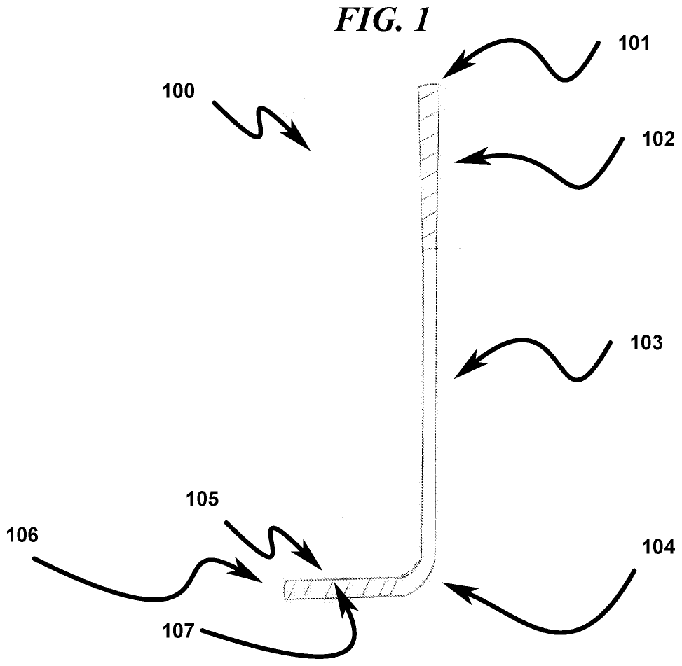

FIG. 1 depicts an exemplary embodiment of the present invention 100 from a side view. The elongated shaft 103 is oriented such that it is placed parallel with a human leg. As stated above, the elongated shaft can be constructed from a wide variety of materials including, but limited to, any type of metal, wood, polymer, or carbon fiber. The elongated shaft 103 does not have to be entirely ridged and can be semi-ridged. When the elongated shaft 103 is placed parallel with the human leg, it is oriented so that the first end 104 is placed pointed away from the body of the human. On the opposite end of the elongated shaft 103 is the second end 101. The handle element 102 is attached to the elongated shaft 103 and it can to a wide variety of forms, as well as be constructed from various materials that are known to one of ordinary skill in the art. Generally, the elongated shaft 103 can be between 24 and 60 inches in length. However, it can be longer or shorter, depending on the needs of the human user.

In FIG. 1, the handle element 102 is depicted as a polymer material that is cut into a long strip and then wraps around the first end 101 of the elongated shaft 103. The wrapping is done is a spiral like manner, moving uniformly along the elongated shaft 103 until the material covers the first end 101. As the material wraps along the elongated shaft, one edge of the material is covered by the material and the other edge covers material so that an overlapping effect is produced. Alternate embodiments may possess different types of handles. For instance, the entire handle element 102 may be constructed of a solid or pieced together rubber unit that is very similar to a golf club handle.

A brace element 105 is affixed to the first end 104 of the elongated shaft 103. As depicted in FIG. 1, the brace element 105 is an arm that is oriented so that it is perpendicular to the elongated shaft 103. Generally, the bracing element is between 2 and 12 inches long, but it can be longer or shorter, depending on the needs of the human user. In addition, FIG. 1 depicts the bracing element 105 to be covered in a grip surface 107 which is a surface or grip that engages the toes to prevent slippage. The grip surface 107 can be a wide variety of materials or substances. For instance, it can be an abrasive material similar to sandpaper or sticky substance. As depicted in FIG. 1, the grip surface 107 is a polymer wrap which is constructed and arranged similar to the handle element 102 described above. The brace element 105 also possesses a distal end 106 that is located on the opposite end from where the brace element 105 is affixed to the elongated shaft 103.

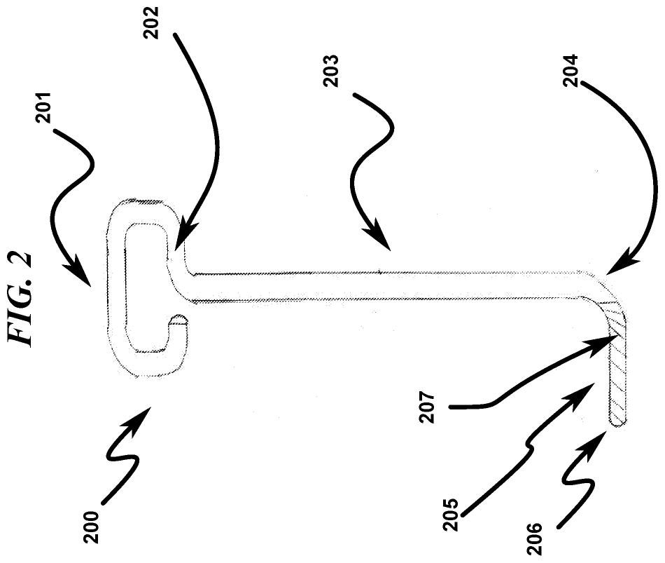

FIG. 2 depicts an alternate embodiment of the present invention 200 from a side view. The elongated shaft 203 is has a first end 201 and a second end 204. In this embodiment, the handle element 202 is designed as a looped handle and affixed to the elongated shaft 203 at the second end 201. The brace element 205 is this embodiment is also affixed to the elongated shaft 203 at the first end 204. Furthermore, the brace element 205 is oriented to be perpendicular to the elongated shaft 203. Similar to FIG. 1, the brace element 205 has a grip surface 207 that is designed to prevent slippage and covers the distal end 206 of the brace element 205.

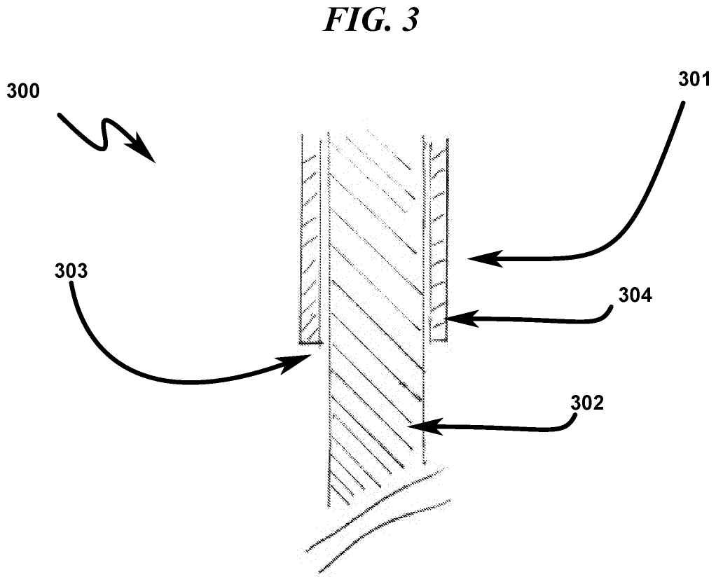

FIG. 3 depicts a close-up view of the present invention 300 in which a telescoping mechanism 303 is depicted. The elongated shaft 301 has two parts. The first part is the outer casing 304, and the second part is the inner casing 302. The inner casing 302 possesses a smaller diameter than the outer casing 304 such that the inner casing 302 can slide in and out of the outer casing 304. A locking mechanism is utilized to lock the inner casing 302 so that it can be fixed in place with regards to the outer casing 304. The locking mechanism can be any number of telescoping tubing locks that are known by one of ordinary skill in the art.

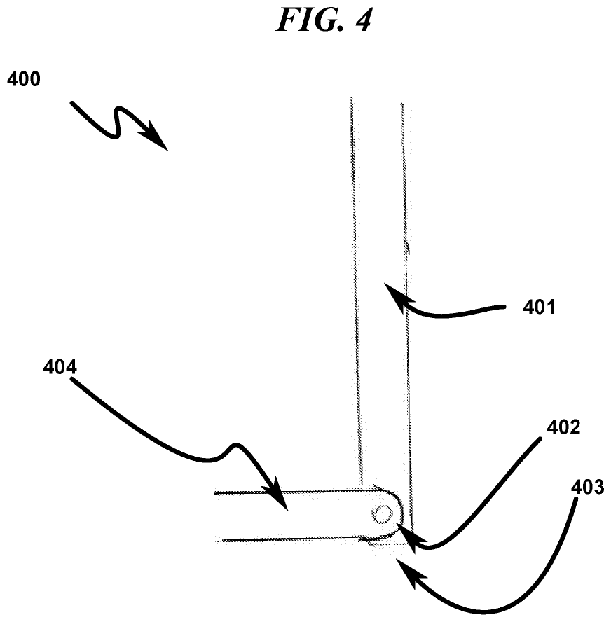

FIG. 4 depicts a close-up view of the present invention 400 in which a hinge 402 is depicted. As illustrated in previous figures, the brace element 404 is displayed affixed at the first end 403 of the elongated shaft 401 and oriented such that it is perpendicular to the elongated shaft 401. The hinge 402 resists the brace element 404 from being oriented at an angle greater than 90 degrees in relation to the elongated shaft 401. However, the hinge 402 allows for the brace element 404 to be folded so that it is parallel to the elongated shaft 401. The hinge 402 allows for the invention to be more easily stored.

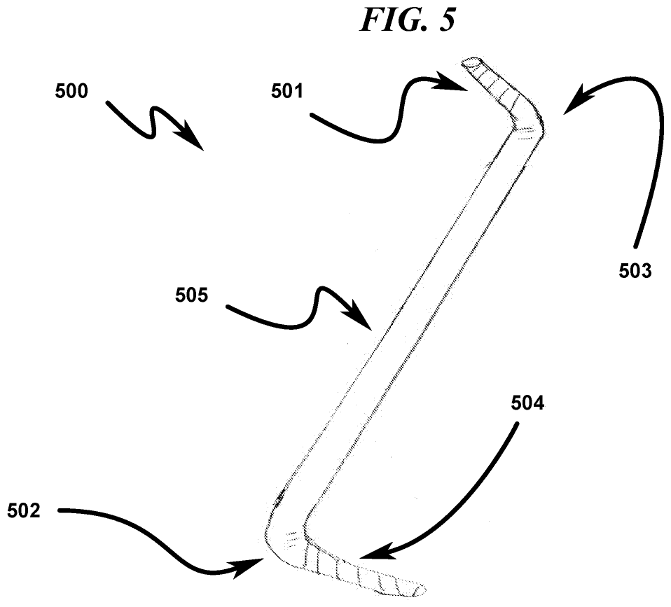

FIG. 5 depicts an alternate embodiment of the present invention 500 from an angled view. In the present embodiment, the elongated shaft 505 has a handle element 501 affixed at the second end 503 and the brace element 504 affixed at the first end 502. Both the handle element 501 and the brace element 504 are displayed as being oriented perpendicular to the elongated shaft 505. The handle element 501 and the brace element 504 are displayed as being perpendicular to each other.

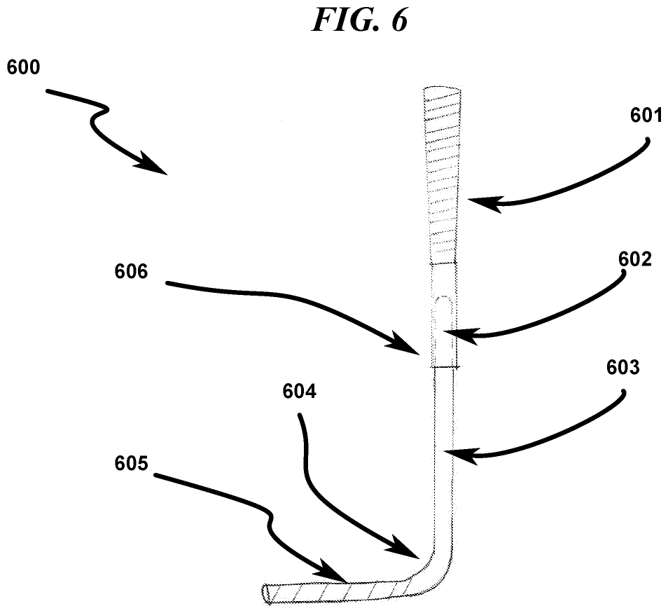

FIG. 6 depicts an alternate embodiment of present invention 600 with a side view, specifically illustrating the telescoping mechanism that allows for the length of the elongated shaft 606 to be adjusted. The elongated shaft is connected to the handle element 601 as displayed and contains two parts. The first part is the outer casing 602, and the second part is the inner casing 603. The inner casing 603 possesses a smaller diameter than the outer casing 602 such that the inner casing 603 can slide in and out of the outer casing 602. A locking mechanism is utilized to lock the inner casing 603 so that it can be fixed in place with regards to the outer casing 602. The locking mechanism can be any number of telescoping tubing locks that are known by one of ordinary skill in the art. Also, the brace element 605 is connected to the inner casing 603 at the first end 604.

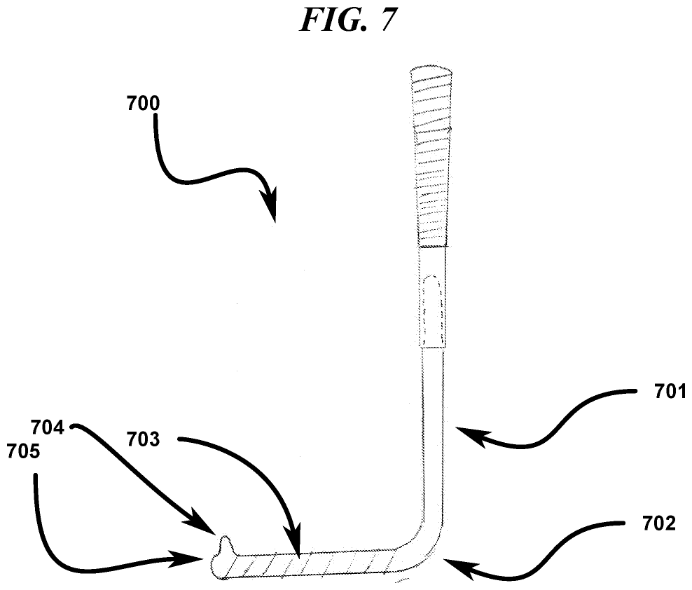

In FIG. 7, an alternate embodiment is displayed that is the same as depicted in FIG. 6 except for the addition of the conical element 704. The elongated shaft 701 is connected at the first end to the brace element 703. In addition, the conical element 704 is affixed at the distal end 705 of the brace element 703. The conical element 704 is a small cone that protrudes out of the brace element 703 and is intended to be used by the human user to manipulate soft tissue and target pressure points, areas of cramping, or scar tissue.

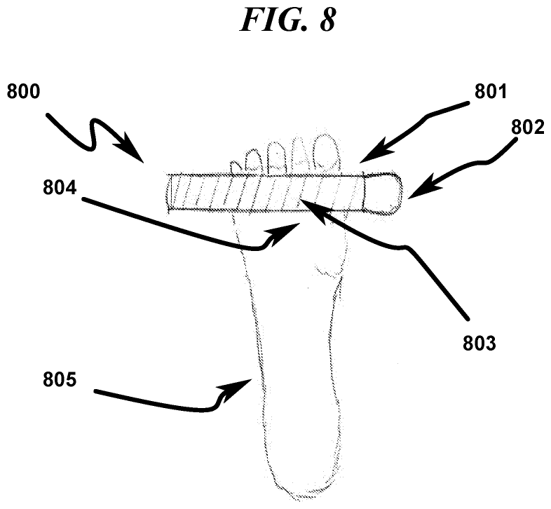

FIG. 8 depicts an environmental view of the present invention 800 with the foot bottom 805 facing outward. The brace element 801 is placed under the digital sulcus 804 of the foot bottom 805. When pressure is applied to the digital sulcus 804 of the foot bottom 805, a stretch of the plantar and posterior portions of the foot and leg, including the Achilles tendon, triceps surae, the hamstring, and the intrinsic musculature of the foot and plantar fascia is initiated. The grip surface 803 is affixed to the brace element 801 to keep the foot bottom 805 from slipping. The foot bottom 805 is depicted centrally located along the brace element 801, away from the distal end 802 of the brace element 801.

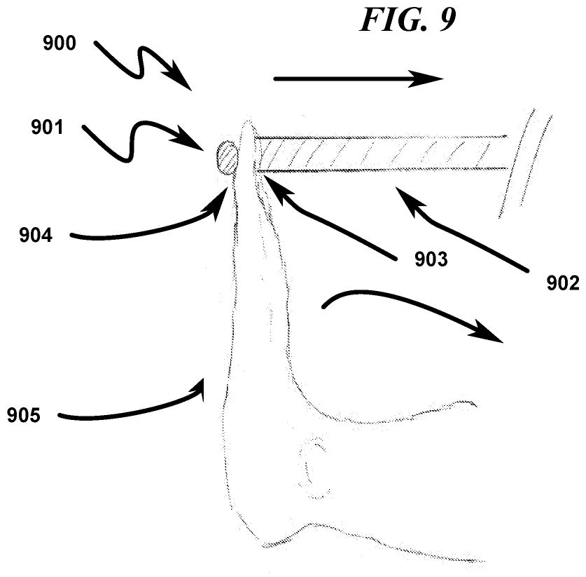

FIG. 9 depicts an environmental view of the present invention 900 from the side. In addition, the direction of that the foot 905 is pulled which is toward the body is displayed. The elongated shaft 902 is affixed to the brace element 901 which, in turn, is centered at the digital sulcus 904 of the foot 905. The human user pulls on the invention such that the brace element engages the foot 905 and bends the toes 903 of the human, thereby initiating the intended stretch on the plantar and posterior portions of the foot and leg.

While this disclosure has been particularly shown and described with reference to preferred embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

While various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically, and by way of example, although the headings refer to a “Technical Field,” the claims should not be limited by the language chosen under this heading to describe the so-called field. Further, a description of a technology as background information is not to be construed as an admission that certain technology is prior art to any embodiment(s) in this disclosure. Neither is the “Brief Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

We claim:

1. A physical therapy device comprising:
An elongated shaft configured to be placed parallel with a human leg, wherein the elongated shaft is oriented such that a first end is located at a point along the elongated shaft that is furthest away from a human torso, and the elongated shaft is also oriented such that a second end is located at a point along the elongated shaft that is furthest way from the first end;
A brace element is affixed to the first end of the elongated shaft, wherein the brace element is configured to engage a human foot;
A handle element affixed to the second end of the elongated shaft, wherein the handle element is further configured to endure pressure from a human hand.

2. The physical therapy device of claim 1, wherein the brace element is further configured to exert pressure on a digital sulcus portion of the human foot.

3. The physical therapy device of claim 2, wherein the brace element is a u-shape that is configured such that an opening of the u-shape wraps around the digital sulcus portion of the human foot.

4. The physical therapy device of claim 1, wherein the handle element is configured to be pulled in a direction away from the human foot;
the handle element further comprises a loop with a grip surface affixed to the loop to prevent slippage, wherein the loop is centered on the axis of the elongated shaft and perpendicular to the brace element such that the human hand is held in a neutral position when the human hand applies pressure to the handle element.

5. The physical therapy device of claim 1, wherein the brace element further comprises a grip surface for preventing slippage.

6. The physical therapy device of claim 5, wherein the grip surface can be constructed of a material selected from the group consisting of leather, rubber, and elastic material.

7. The physical therapy device of claim 1, wherein the physical therapy device can be constructed of material selected from the group consisting of metal, wood, polymer, and carbon fiber.

8. The physical therapy device of claim 1, wherein the brace element is a loop that is configured such that an aperture of the loop allows for a distal end of the human foot to pass through it.

9. The physical therapy device of claim 1, wherein the brace element is an arm that is oriented perpendicular to the elongated shaft.

10. The physical therapy device of claim 9, wherein the brace element is affixed to the elongated shaft with a hinge that allows for the brace element to be reoriented such that the brace element is parallel to the elongated shaft.

11. The physical therapy device of claim 9, wherein the brace element has a length of 2 inches to 12 inches.

12. The physical therapy device of claim 1, wherein the elongated shaft has a length from 24 inches to 60 inches.

13. The physical therapy device of claim 12, wherein the elongated shaft further comprises an adjustment mechanism that allows for the length of the elongated shaft to be adjusted to match the length of the human leg.

14. The physical therapy device of claim 1, wherein the brace element has a conical member, wherein the conical member is configured to manipulate soft tissue on the human foot.

15. A method for stretching muscles in a human body, the method comprising:
Placing an elongated shaft parallel with a human leg, wherein the elongated shaft is oriented such that the first end is located at a point along the elongated shaft that is furthest away from a human torso, and the elongated shaft is also oriented such that a second end is located at a point along the elongated shaft that is furthest way from the first end;
Exerting pressure with a human hand on a handle element that is affixed to the second end of the elongated shaft;
Engaging a human foot with a brace element that is affixed to the elongated shaft at the first end;
After engaging the human foot, holding the handle element such that pressure is continually exerted by the human hand on the handle element and the brace element continually engages the human foot, wherein muscles in the human body continually experience stretching.

16. The method of claim 15, wherein the brace element is further configured to engage a digital sulcus portion of the human foot.

17. The method of claim 15 further comprising: pulling the handle element with the human hand in a direction away from the human foot;
the handle element further comprises a loop with a grip surface affixed to the loop to prevent slippage, wherein the loop is centered on the axis of the elongated shaft and perpendicular to the brace element such that the human hand is held in a neutral position when the human hand applies pressure to the handle element.

18. The method of claim 15 further comprising: adjusting the length of the elongated shaft to match the length of a human leg.

19. The method of claim 15 further comprising: manipulating soft tissue on the human foot with a conical member, wherein the conical member is affixed to the brace element.

20. The method of claim 15 further comprising: discontinuing exerting pressure with the human hand on the handle element such that the handle element no longer endures pressure by the human hand, the human foot is no longer engaged by the brace element, and the muscles in the human body no longer experience stretching.
